(19) United States
(12) Patent Application Publication
(10) Pub. No.: US 2026/0302546 A1
(43) Pub. Date: Oct. 1, 2026

(54) CYLINDRICAL SECONDARY BATTERY

(71) Applicant: Panasonic Intellectual Property Management Co., Ltd., Kadoma-shi, Osaka (JP)

(72) Inventors: Yuki Nishinaka, Osaka (JP); Fumikazu Mizukoshi, Osaka (JP); Atsushi Mizawa, Hyogo (JP)

(73) Assignee: Panasonic Intellectual Property Management Co., Ltd., Kadoma-shi, Osaka (JP)

(21) Appl. No.: 19/476,892

(22) PCT Filed: Apr. 9, 2024
(86) PCT No.: PCT/JP2024/014357

§ 371 Date: Oct. 20, 2025

(30) Foreign Application Priority Data
Apr. 28, 2023 (JP) 2023-075175

(51) Int. Cl. H01M 50/533; H01M 10/052; H01M 10/0587; H01M 50/107

(52) U.S. Cl. CPC H01M 50/533; H01M 10/052; H01M 10/0587; H01M 50/107; H01M 2300/0034

(57) ABSTRACT

The first electrode has a first core body and a first mixture layer formed on the surface of the first core body. A first core body exposed part, at which the first core body is exposed, is disposed at one end of the electrode body in the winding axis direction. The first core body exposed part has a first bent point and is joined to a first current collector plate. When the first core body exposed part is divided into a first region on the first current collector plate side with respect to the first bent point and a second region on the first mixture layer side with respect to the first bent point, the surface hardness H1 of the first region and the surface hardness H2 of the second region satisfy the relationship H1<H2.

### TECHNICAL FIELD

The present disclosure relates to a cylindrical secondary battery.

### BACKGROUND ART

Conventionally, a cylindrical secondary battery has been known, formed by allowing a core of an electrode to protrude from an end surface in the axial direction of an electrode assembly and laser-welding the protruded core to a current collecting plate. For example, Patent Literature 1 discloses a current collecting plate having a projecting press surface on the side facing the core for the purpose of increasing the contact area between the current collecting plate and the core to suppress the electric resistance of the electrode.

### CITATION LIST

### Patent Literature

PATENT LITERATURE 1: Japanese Unexamined Patent Application Publication No. 2010-257851

### SUMMARY

As a result of intensive studies, the present inventors have found that when the core is too soft, a bonding failure between the current collecting plate and the core may occur and when the core is too hard, the electrode may be stretched by plastic deformation due to repeated charge and discharge, increasing the risk of occurrence of a short circuit. The technique described in Patent Literature 1 does not investigate the compatibility between bonding failure suppression and poor elongation suppression, and thus still has room for improvement.

It is therefore an advantage of the present disclosure to provide a cylindrical secondary battery with suppressed bonding failure and poor elongation.

A cylindrical secondary battery of an aspect of the present disclosure comprises: an electrode assembly in which a first electrode and a second electrode having different polarities from each other are wound via a separator; a non-aqueous electrolyte; and a bottomed cylindrical exterior housing can housing the electrode assembly and the non-aqueous electrolyte, wherein the first electrode has a first core and a first mixture layer formed on a surface of the first core, a first core exposed portion where the first core is exposed is disposed at one end of the electrode assembly in a winding axis direction, the first core exposed portion having a first bending point and being bonded to a first current collecting plate, and when the first core exposed portion is divided into a first region extending from the first bending point toward the first current collecting plate and a second region extending from the first bending point toward the first mixture layer, surface hardness H1 of the first region and surface hardness H2 of the second region satisfy a relationship of H1<H2.

According to the cylindrical secondary battery of the present disclosure, bonding failure and poor elongation can be suppressed.

### BRIEF DESCRIPTION OF DRAWING

FIG. 1 is an axial sectional view of a cylindrical secondary battery according to an embodiment of the present disclosure.

FIG. 2 is a perspective view of a wound electrode assembly comprised in the cylindrical secondary battery shown in FIG. 1.

FIG. 3 is an enlarged view of the vicinity of an upper end of an electrode assembly comprised in the cylindrical secondary battery shown in FIG. 1.

FIG. 4 is an enlarged view of the vicinity of the lower end of an electrode assembly comprised in the cylindrical secondary battery shown in FIG. 1.

### DESCRIPTION OF EMBODIMENTS

Conventionally, a cylindrical secondary battery has been known, formed by allowing the positive electrode core and the negative electrode core to protrude from the upper and lower ends of the electrode assembly in the winding axis direction, and bonding these cores to two current collecting plates respectively disposed on the upper and lower sides of the electrode assembly. As a result of intensive studies, the present inventors have found that when the core is too hard, a bonding failure between the current collecting plate and the core may occur and when the core is soft, the electrode may be stretched by plastic deformation due to repeated charge and discharge, increasing the risk of occurrence of a short circuit. If the core is hard, the core may not bend sufficiently, causing bonding failure in welding the core to the current collecting plate. On the other hand, if the core is soft, repeated charge and discharge may cause the electrode to stretch and reach the current collecting plate on the opposite side of the bonded current collecting plate, leading to a short circuit.

As a result of further intensive studies, the present inventors have found that bonding failure suppression and poor elongation suppression can both be achieved by adjusting the hardness of the core, forming at least one of the group consisting of the positive electrode and the negative electrode for each predetermined region. Specifically, the effect described above is obtained by making the surface hardness of the region from the bending point to the current collecting plate side lower than the surface hardness of the region from the bending point to the mixture layer side.

Hereinafter, an example of an embodiment of a cylindrical secondary battery according to the present disclosure will be described in detail with reference to the drawings. In the following description, specific shapes, materials, values, directions, and the like, which are examples for facilitating understanding of the present invention, may be appropriately modified with specifications of cylindrical secondary batteries. In the following description, when a plurality of embodiments and modifications are included, it is assumed from the beginning that characteristics portions thereof are used in combination as appropriate.

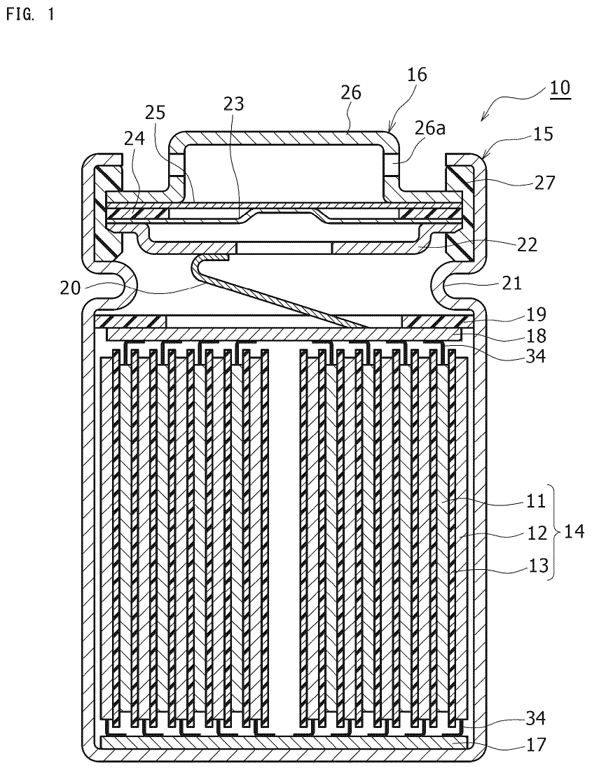

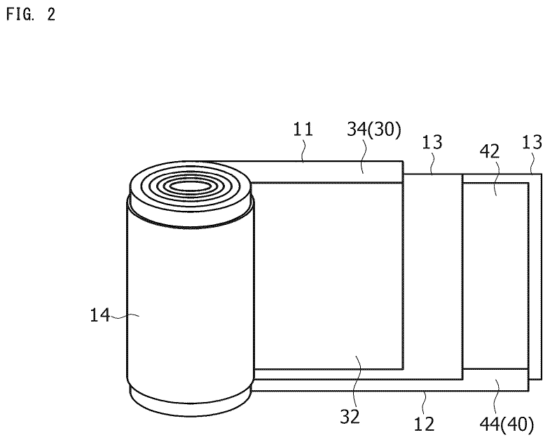

FIG. 1 is an axial sectional view of a cylindrical secondary battery 10 according to an embodiment of the present disclosure, and FIG. 2 is a perspective view illustrating the structure of an electrode assembly 14. As shown in FIG. 1, the cylindrical secondary battery 10 comprises a wound electrode assembly 14, a non-aqueous electrolyte (not shown), a metal exterior housing can 15 that has a bottomed cylindrical shape and houses the electrode assembly 14 and the non-aqueous electrolyte, and a sealing assembly 16 blocking an opening portion of the exterior housing can 15. For convenience of description, a sealing assembly 16 side will be described as the “upper side”, and the bottom side of the exterior housing can 15 will be described as the “lower side”.

As shown in FIG. 2, the electrode assembly 14 has a wound structure in which an elongated positive electrode 11 and an elongated negative electrode 12 are wound via two elongated separators 13. In addition, the positive electrode 11 protrudes upward from the negative electrode 12 and the separator 13, and the negative electrode 12 protrudes downward from the positive electrode 11 and the separator 13. The positive electrode 11 has a positive electrode core exposed portion 34, in which the positive electrode core 30 is exposed without a positive electrode mixture layer 32, at the upper end in the winding axis direction (hereinafter sometimes referred to as the axial direction) from the end on the winding start side to the end on the winding end side in the longitudinal direction of the elongated positive electrode 11. The negative electrode 12 has a negative electrode core exposed portion 44, in which the negative electrode core 40 is exposed without a negative electrode mixture layer 42, at the lower end in the axial direction from the end on the winding start side to the end on the winding end side in the longitudinal direction of the elongated negative electrode 12. Accordingly, the upper axial end of the electrode assembly 14 is composed of the positive electrode core exposed portion 34, and the lower axial end of the electrode assembly 14 is composed of the negative electrode core exposed portion 44. The width of the positive electrode core exposed portion 34 (i.e., the length in the width direction of the electrode assembly 14) is, for example, greater than or equal to 2 mm and less than or equal to 20 mm. The width of the negative electrode core exposed portion 44 (i.e., the length in the axial direction of the electrode assembly 14) is also, for example, greater than or equal to 2 mm and less than or equal to 20 mm. In the present embodiment, a case where the first electrode is the positive electrode 11 and the second electrode is the negative electrode 12 will be described. However, alternatively, the first electrode may be the negative electrode 12 and the second electrode may be the positive electrode 11.

The non-aqueous electrolyte has lithium ion conductivity. The non-aqueous electrolyte may be a liquid electrolyte (electrolyte solution) or a solid electrolyte.

The liquid electrolyte (electrolyte solution) includes a non-aqueous solvent and an electrolyte salt dissolved in the non-aqueous solvent. As the non-aqueous solvent, for example, esters, ethers, nitriles, amides, and mixed solvents composed of two or more of these solvents may be used. Examples of the non-aqueous solvent include ethylene carbonate (EC), ethyl methyl carbonate (EMC), dimethyl carbonate (DMC), diethyl carbonate (DEC), and mixed solvents thereof. The non-aqueous solvent may also contain a halogen-substituted product (e.g., fluoroethylene carbonate) in which at least a portion of the hydrogen atoms in these solvents are replaced with halogen atoms such as fluorine. As the electrolyte salt, for example, a lithium salt such as LiPF₆ is used.

As the solid electrolyte, for example, a solid or gel-type polymer electrolyte or an inorganic solid electrolyte may be used. As the inorganic solid electrolyte, materials known for use in all-solid lithium-ion secondary batteries (oxide-based solid electrolytes, sulfide-based solid electrolytes, halogen-based solid electrolytes, etc.) may be used. The polymer electrolyte includes, for example, a lithium salt and a matrix polymer, or a non-aqueous solvent, a lithium salt, and a matrix polymer. As the matrix polymer, for example, polymer materials capable of absorbing the non-aqueous solvent and forming a gel may be used. Examples of the polymer materials include fluororesins, acrylic resins, and polyether resins.

The positive electrode 11 has a positive electrode core 30 and a positive electrode mixture layer 32 formed on both surfaces of the positive electrode core 30. As the positive electrode core 30, a metal foil that is stable in the potential range of the positive electrode 11, such as aluminum or an aluminum alloy, and a film with the metal disposed on the surface layer, or the like can be used. The thickness of the positive electrode core 30 is, for example, greater than or equal to 10 μm and less than or equal to 30 μm. The positive electrode mixture layer 32 includes a positive electrode active material, a conductive agent, and a binder. The positive electrode 11 can be produced, for example, by applying a positive electrode mixture slurry including the positive electrode active material, the conductive agent, the binder, and the like to the positive electrode core 30, drying the coating film, and then compressing the coating film to form the positive electrode mixture layer 32 on both surfaces of the positive electrode core 30. Note that the positive electrode mixture layer 32 may be formed on one side of the positive electrode core 30. The thickness of the positive electrode mixture layer 32 is, for example, greater than or equal to 10 μm and less than or equal to 150 μm on one side of the positive electrode core 30.

The positive electrode active material is composed mainly of a lithium-containing metal composite oxide. Examples of the metal elements contained in the lithium-containing metal composite oxide include Ni, Co, Mn, Al, B, Mg, Ti, V, Cr, Fe, Cu, Zn, Ga, Sr, Zr, Nb, In, Sn, Ta, and W. A preferred example of the lithium-containing metal composite oxide is a composite oxide containing at least one of the group consisting of Ni, Co, Mn, and Al.

Examples of the conductive agent included in the positive electrode mixture layer 32 include carbon materials such as carbon black, acetylene black, Ketjenblack, and graphite. Examples of the binder included in the positive electrode mixture layer 32 include a fluororesin such as polytetrafluoroethylene (PTFE) and polyvinylidene fluoride (PVdF), polyacrylonitrile (PAN), a polyimide resin, an acrylic resin, and a polyolefin resin. These resins may be used in combination with a cellulose derivative such as carboxymethyl cellulose (CMC) or a salt thereof, polyethylene oxide (PEO), or the like.

The negative electrode 12 has a negative electrode core 40 and a negative electrode mixture layer 42 formed on both surfaces of the negative electrode core 40. As the negative electrode core 40, a metal foil that is stable in the potential range of the negative electrode 12, such as copper or a copper alloy, and a film with the metal disposed on the surface layer, or the like can be used. The thickness of the negative electrode core 40 is, for example, greater than or equal to 5 μm and less than or equal to 30 μm. The negative electrode mixture layer 42 includes a negative electrode active material and a binder. The negative electrode 12 can be produced, for example, by applying a negative electrode mixture slurry including the negative electrode active material, the binder, and the like to the negative electrode core 40, drying the coating film, and then compressing the coating film to form the negative electrode mixture layer 42 on both surfaces of the negative electrode core 40. Note that the negative electrode mixture layer 42 may be formed on one surface of the negative electrode core 40. The thickness of the negative electrode mixture layer 42 is, for example, greater than or equal to 10 μm and less than or equal to 150 μm on one side of the negative electrode core 40.

As the negative electrode active material, carbon materials that reversibly occlude and release lithium ions are typically used. Preferred carbon materials are graphite including natural graphite such as flake graphite, massive graphite, and amorphous graphite, and artificial graphite such as massive artificial graphite and graphitized mesophase carbon microbead. The negative electrode mixture layer 42 may include a Si material containing silicon (Si) as the negative electrode active material. As the negative electrode active material, a metal alloyed with lithium other than Si, an alloy containing the metal, a compound containing the metal, or the like may be used.

As the binder included in the negative electrode mixture layer 42, similarly to the case of the positive electrode 11, a fluororesin, PAN, a polyimide resin, an acrylic resin, a polyolefin resin, and the like may be used, and styrene-butadiene rubber (SBR) or a modified product thereof is preferably used. The negative electrode mixture layer 42 may include, in addition to SBR, CMC or a salt thereof, polyacrylic acid (PAA) or a salt thereof, or polyvinyl alcohol, for example.

For the separator 13, a porous sheet having an ion permeation property and an insulation property is used. Specific examples of the porous sheet include a microporous thin film, a woven fabric, and a nonwoven fabric. The material of the separator 13 is preferably a polyolefin resin such as polyethylene or polypropylene, cellulose, or the like. The separator 13 may have either a single-layer structure or a multilayer structure. A heat-resistant layer or the like may be formed on the surface of the separator 13.

As shown in FIG. 1, the cylindrical secondary battery 10 has a negative electrode current collecting plate 17 made of a metal such as nickel or a nickel alloy on the lower side of the electrode assembly 14 in the axial direction. The negative electrode core exposed portion 44, protruding from the electrode assembly 14, is bonded to the negative electrode current collecting plate 17, and the negative electrode current collecting plate 17 is bonded to the inner surface of the bottom plate of the exterior housing can 15. The exterior housing can 15, which is electrically connected to the negative electrode core exposed portion 44 via the negative electrode current collecting plate 17, serves as the negative electrode terminal.

The cylindrical secondary battery 10 has a positive electrode current collecting plate 18 made of metal such as aluminum or an aluminum alloy on the upper side of the electrode assembly 14 in the axial direction. The positive electrode core exposed portion 34, protruding from the electrode assembly 14, is bonded to the positive electrode current collecting plate 18. The cylindrical secondary battery 10 has an annular insulating plate 19 on the upper side of the positive electrode current collecting plate 18 in the axial direction.

The cylindrical secondary battery 10 further comprises a sealing assembly 16 and a connection lead 20 composed of a metal such as aluminum or an aluminum alloy. The lower end of the connection lead 20 is bonded to the upper surface of the positive electrode current collecting plate 18 by welding or the like. The connection lead 20 extends toward the sealing assembly 16 through a through hole of the insulating plate 19, and the upper end of the connection lead 20 is connected to the lower surface of the filter 22 of the sealing assembly 16 by welding or the like. A cap 26 constituting a top plate of the sealing assembly 16 is electrically connected to the filter 22, whereby the cap 26 serves as a positive electrode terminal.

The cylindrical secondary battery 10 further comprises a resin gasket 27 disposed between the exterior housing can 15 and the sealing assembly 16. The gasket 27 is clamped between the exterior housing can 15 and the sealing assembly 16, electrically insulating the sealing assembly 16 from the exterior housing can 15. The gasket 27 serves both as a sealing material to maintain airtightness within the battery and as an insulating material to insulate the exterior housing can 15 from the sealing assembly 16. The exterior housing can 15 has an annular grooved portion 21 in a part of the axial direction.

The grooved portion 21 can be formed, for example, by spinning a part of the side surface radially inward to create a recessed shape in the radial direction. The exterior housing can 15 has a bottomed cylindrical portion including the grooved portion 21 and an annular shoulder portion. The bottomed cylindrical portion houses the electrode assembly 14 and the non-aqueous electrolyte, and the shoulder portion is bent radially inward from an end of the bottomed cylindrical portion on an opening side and extends inward. The shoulder portion is formed when an upper end of the exterior housing can 15 is bent inward and crimped to the circumferential parts thereof of the sealing assembly 16. The sealing assembly 16 is crimped and fixed to the exterior housing can 15 via a gasket 27 between the shoulder portion and the grooved portion 21. In this manner, the interior space of the cylindrical secondary battery 10 is sealed.

The sealing assembly 16 has a structure in which a filter 22, a lower vent member 23, an insulating member 24, an upper vent member 25, and the cap 26 are stacked in this order from the electrode assembly 14 side. Each member constituting the sealing assembly 16 has, for example, a disk shape or a ring shape, and each member except for the insulating member 24 is electrically connected to each other. The filter 22 has at least one through hole. The lower vent member 23 and the upper vent member 25 are connected at respective central parts thereof, and the insulating member 24 is interposed between the respective circumferential parts thereof.

If the internal pressure of the cylindrical secondary battery 10 increases due to abnormal heat generated by the cylindrical secondary battery 10, the lower vent member 23 deforms and breaks in such a manner as to push the upper vent member 25 toward the cap 26 side, thereby interrupting the current path between the lower vent member 23 and the upper vent member 25. If the internal pressure further increases, the upper vent member 25 breaks, and gas is discharged through the through hole 26a of a cap 26. The discharge of this gas can prevent the internal pressure of the cylindrical secondary battery 10 from excessively increasing and causing the cylindrical secondary battery 10 to rupture, thereby improving the safety of the cylindrical secondary battery 10.

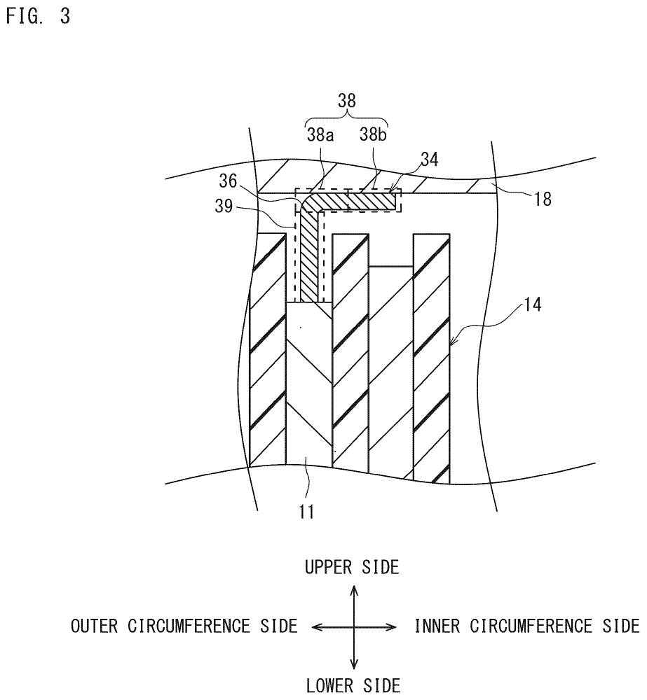

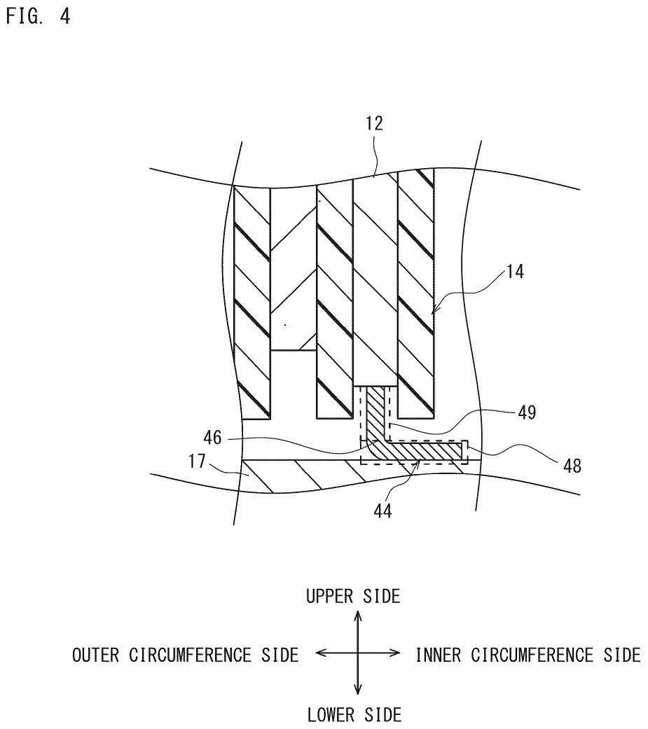

Next, with reference to FIGS. 3 and 4, the bonding of the electrode assembly 14 and the positive electrode current collecting plate 18 in the upper portion of the cylindrical secondary battery 10 and the bonding of the electrode assembly 14 and the negative electrode current collecting plate 17 in the lower portion of the cylindrical secondary battery 10 will be described. FIG. 3 is an enlarged view of the vicinity of an upper end of the electrode assembly 14 comprised in the cylindrical secondary battery 10, and FIG. 4 is an enlarged view of the vicinity of the lower end of the electrode assembly 14 comprised in the cylindrical secondary battery 10.

As shown in FIG. 3, the positive electrode core exposed portion 34 extends substantially parallel to the axial direction of the electrode assembly 14 from the upper end surface of the electrode assembly 14. The positive electrode core exposed portion 34, which has a bending point 36, is bonded to the positive electrode current collecting plate 18. The bending point 36 is a point at which, when the positive electrode core exposed portion 34 is viewed from the electrode assembly 14 side, the positive electrode core exposed portion 34 is inclined at 30° or more toward the inner circumference side with respect to the axial direction of the electrode assembly 14. In the vicinity of the bending point 36, the angle of the positive electrode core exposed portion 34 changes by about 90° from substantially parallel to the axial direction of the electrode assembly 14 to substantially parallel to the surface of the positive electrode current collecting plate 18.

When the positive electrode core exposed portion 34 is divided into a first region 38 extending from the bending point 36 to the positive electrode current collecting plate and a second region 39 from the bending point 36 to the positive electrode mixture layer 32, the surface hardness H1 of the first region 38 and the surface hardness H2 of the second region 39 satisfy the relationship of H1<H2. Thus, both bonding failure suppression and poor elongation suppression can be achieved.

The first region 38 is divided in half in the width direction of the electrode assembly 14 such that a bending point 36 side is defined as a 1-1 region 38a and a positive electrode current collecting plate 18 side is defined as a 1-2 region 38b, surface hardness H1-1 of the 1-1 region 38a and surface hardness H1-2 of the 1-2 region 38b preferably satisfy a relationship of H1-1<H1-2.

The surface hardness in the present specification is a value measured by using a dynamic ultra-micro hardness tester DUH 211S manufactured by Shimadzu Corporation. Using this testing apparatus, a loading-unloading test (MODE2) is conducted. More specifically, after the triangular pyramidal indenter (interfacial angle: 115°) comes into contact with the sample, a load is applied at a constant loading rate until it reaches 20 mN. The load is then held for 10 seconds, followed by unloading at a constant rate.

The surface hardness H1-1 is calculated by averaging the measurement results at 5 points in the 1-1 region 38a. The surface hardness H1-2 is calculated by averaging the measurement results at 5 points in the 1-2 region 38b. The measurement results at 5 points in the 1-1 region 38a and the measurement results at 5 points in the 1-2 region 38b are combined and averaged to calculate the surface hardness H1. The surface hardness H2 is calculated by averaging the measurement results at 10 points in the second region 39.

The surface hardness H1 and the surface hardness H2 preferably satisfy a relationship of H1/H2<0.6. The surface hardness H1 satisfies, for example, 20 GPa<H1<100 GPa. The surface hardness H2 satisfies, for example, 50 GPa<H2<150 GPa.

As shown in FIG. 4, the negative electrode core exposed portion 44 extends substantially parallel to the axial direction of the electrode assembly 14 from the lower end surface of the electrode assembly 14. The negative electrode core exposed portion 44, which has a bending point 46, is bonded to the negative electrode current collecting plate 17. The bending point 46 is a point at which, when the negative electrode core exposed portion 44 is viewed from the electrode assembly 14 side, the negative electrode core exposed portion 44 is inclined at 30° or more toward the inner circumference side with respect to the axial direction of the electrode assembly 14. In the vicinity of the bending point 46, the angle of the negative electrode core exposed portion 44 changes by about 90° from substantially parallel to the axial direction of the electrode assembly 14 to substantially parallel to the surface of the positive electrode current collecting plate 18.

When the negative electrode core exposed portion 44 is divided into a third region 48 extending from the bending point 46 to the negative electrode current collecting plate side and a fourth region 49 from the bending point 46 to the negative electrode mixture layer 42 side, the surface hardness H3 of the third region 48 and the surface hardness H4 of the fourth region 49 satisfy the relationship of H3<H4. When H1<H2 and H3<H4 are satisfied, the effect of suppressing bonding failure and poor elongation becomes more remarkable.

The surface hardness H3 and the surface hardness H4 preferably satisfy a relationship of H3/H4<0.6. The surface hardness H3 satisfies, for example, 100 GPa<H3<300 GPa. The surface hardness H4 satisfies, for example, 250 GPa<H4<500 GPa.

The surface hardness H1 and the surface hardness H3 preferably satisfy a relationship of 0.25≤H1/H3≤1.1. Accordingly, the balance of hardness between the positive electrode and the negative electrode is improved, and the effect of suppressing bonding failure and poor elongation becomes more remarkable.

The surface hardness of the positive electrode core exposed portion 34 can be adjusted by, for example, subjecting the positive electrode core exposed portion 34 to heat treatment. More specifically, the relationship of H1<H2 can be satisfied by subjecting only the first region 38 to heat treatment, while the second region 39 is not heat-treated. Increasing the heat treatment temperature makes the positive electrode core exposed portion 34 soft and the numerical value of the surface hardness small. In addition, the numerical value of the surface hardness of the positive electrode core exposed portion 34 also becomes small by increasing the heat treatment time. The heat treatment temperature may be, for example, greater than or equal to 100° C. and less than or equal to 250° C. The heat treatment time may be, for example, greater than or equal to 3 seconds and less than or equal to 60 seconds.

The positive electrode core exposed portion 34 can be subjected to heat treatment by, for example, contacting only the first region 38 with a high-temperature roller. For example, the heat treatment temperature and heat treatment time can be adjusted by adjusting the temperature and rotation speed of the roller. When the numerical value of the surface hardness is changed between the 1-1 region 38a and the 1-2 region 38b, the 1-1 region 38a and the 1-2 region 38b may be heat-treated under different conditions. The heat treatment of the positive electrode core exposed portion 34 may be performed before the positive electrode mixture layer 32 is formed on the surface of the positive electrode core 30, or after the positive electrode mixture layer 32 is formed on the surface of the positive electrode core 30. The surface hardness of the negative electrode core exposed portion 44 can also be adjusted by heat treatment in the same manner as the surface hardness of the positive electrode core exposed portion 34.

### EXAMPLES

Hereinafter, the present disclosure will be further described with Examples, but the present disclosure is not limited to these Examples.

### Example 1

### [Production of Positive Electrode]

A band-shaped aluminum foil having a surface hardness of 100 GPa and a thickness of 15 μm was prepared. A portion corresponding to H1 on one side in the bandwidth direction of the aluminum foil was subjected to heat treatment while being in contact with a roller at 150° C. for 10 seconds. Separately, 100 parts by mass of the positive electrode active material, 1 part by mass of acetylene black (AB), and 0.9 parts by mass of polyvinylidene fluoride (PVDF) were mixed, and an appropriate amount of N-methyl-2-pyrrolidone (NMP) was added to prepare a positive electrode mixture slurry. As a positive electrode active material, an aluminum-containing lithium nickel cobaltate represented by LiNi_{0.88}Co_{0.09}Al_{0.03}O₂ was used. Next, the positive electrode mixture slurry was applied to both surfaces of the aluminum foil so that the positive electrode core exposed portions H1 and H2 were formed. The coating film was dried, then rolled, and cut into a predetermined electrode size to produce a positive electrode in which a positive electrode mixture layer was formed on both surfaces of the positive electrode core. The axial lengths of H1 and H2 formed in the positive electrode core exposed portion were each 3 mm.

### [Production of Negative Electrode]

A band-shaped copper foil having a surface hardness of 300 GPa and a thickness of 8 μm was prepared. A portion corresponding to H3 on one side in the bandwidth direction of the copper foil was subjected to heat treatment while being in contact with a roller at 150° C. for 10 seconds. Separately, mixing 95 parts by mass of graphite, 5 parts by mass of SiO oxide (SiO), 1 part by mass of sodium carboxymethylcellulose (CMC-Na), 1 part by mass of styrene-butadiene rubber (SBR) were performed, and an appropriate amount of water was added to prepare a negative electrode mixture slurry. Next, the negative electrode mixture slurry was applied to both surfaces of the copper foil so that the negative electrode core exposed portions H3 and H4 were formed. The coating film was dried, then rolled, and cut into a predetermined electrode size to produce a negative electrode in which a negative electrode mixture layer was formed on both surfaces of the negative electrode core. The lengths of H3 and H4 formed in the negative electrode core exposed portion were each 3 mm.

### [Preparation of Non-Aqueous Electrolyte]

To 100 parts by mass of a mixed solvent in which ethylene carbonate (EC) and dimethyl carbonate (DMC) were mixed at a volume ratio of 3:7 was added 5 parts by mass of vinylene carbonate (VC), lithium hexafluorophosphate (LiPF₆) was dissolved in the mixture at a concentration of 1.5 mol/liter, thereby preparing a non-aqueous electrolyte.

### [Production of Test Cell]

The positive electrode and the negative electrode were spirally wound via a microporous membrane separator made of polyethylene to produce a wound electrode assembly. A positive electrode current collecting plate and a negative electrode current collecting plate were respectively disposed on the upper and lower sides of the electrode assembly, and the positive electrode core exposed portion extending from the upper end and the negative electrode core exposed portion extending from the lower end of the electrode assembly were bent toward the inner circumference side and then welded to the positive electrode current collecting plate and the negative electrode current collecting plate. Thereafter, the electrode assembly was housed in a bottomed cylindrical exterior housing can, the negative electrode current collecting plate was welded to the bottom of the bottomed cylindrical exterior housing can, and the positive electrode current collecting plate and the sealing assembly were connected using a connection tab. The non-aqueous electrolyte was injected into the exterior housing can, and an opening portion of the exterior housing can was sealed with the sealing assembly via a gasket to produce a cylindrical test cell.

### [Evaluation of Welding Failure Rate]

For 100 test cells, the connection state between the positive electrode current collecting plate and the positive electrode core exposed portion, and the connection state between the negative electrode current collecting plate and the negative electrode core exposed portion were confirmed. It was determined that welding failure had occurred when there were areas not in contact with the current collecting plate and the end of the core, resulting in failure to weld the uncontacted areas during welding.

### [Evaluation of Poor Elongation Rate]

A total of 100 test cells were prepared, and the following charge-discharge cycle was repeated 500 times for each test cell. After the charge-discharge cycle, the test cell was subjected to cross-sectional observation for each sample using an X-ray CT apparatus (SMX-225 CT FPD HR, manufactured by Shimadzu Corporation). It was determined that the poor elongation occurred when the end of the negative electrode mixture layer in the upper portion of the electrode assembly was stretched due to the charge-discharge cycle and was in contact with the positive electrode core exposed portion, and when the end of the positive electrode mixture layer in the lower portion of the electrode assembly was stretched due to the charge-discharge cycle and was in contact with the negative electrode core exposed portion.

### [Charge-Discharge Cycle]

The test cell was charged under a temperature environment of 25° C. at a constant current of 0.3 C until a battery voltage reached 4.2 V, and then charged at a constant voltage of 4.2 V until a current value reached 0.01 C. Thereafter, the test cell was discharged to 2.5 V at a constant current of 0.5 C, and this charge-discharge operation was defined as one cycle.

### Example 2

A test cell was produced and evaluated in the same manner as in Example 1, except that heat treatment was performed by setting the temperature of the roller to 150° C. and changing the contact time of the roller to 30 seconds in the production of the positive electrode, and heat treatment was performed by setting the temperature of the roller to 150° C. and changing the contact time of the roller to 30 seconds in the production of the negative electrode. H1, H2, H3, and H4 were 70 GPa, 100 GPa, 210 GPa, and 300 GPa, respectively.

### Example 3

A test cell was produced and evaluated in the same manner as in Example 1, except that heat treatment was performed by setting the temperature of the roller to 150° C. and changing the contact time of the roller to 25 seconds in the production of the positive electrode, and heat treatment was performed by setting the temperature of the roller to 150° C. and changing the contact time of the roller to 20 seconds in the production of the negative electrode. H1, H2, H3, and H4 were 40 GPa, 100 GPa, 210 GPa, and 120 GPa, respectively.

### Example 4

A test cell was produced and evaluated in the same manner as in Example 1, except that heat treatment was performed by setting the temperature of the roller to 150° C. and changing the contact time of the roller to 30 seconds in the production of the positive electrode, and heat treatment was performed by setting the temperature of the roller to 150° C. and changing the contact time of the roller to 8 seconds in the production of the negative electrode. H1, H2, H3, and H4 were 40 GPa, 100 GPa, 240 GPa, and 300 GPa, respectively.

### Example 5

A test cell was produced and evaluated in the same manner as in Example 1, except that heat treatment was performed by setting the temperature of the roller to 150° C. and changing the contact time of the roller to 15 seconds in the production of the positive electrode, and heat treatment was performed by setting the temperature of the roller to 150° C. and changing the contact time of the roller to 30 seconds in the production of the negative electrode. H1, H2, H3, and H4 were 60 GPa, 100 GPa, 90 GPa, and 300 GPa, respectively.

### Example 6

A test cell was produced and evaluated in the same manner as in Example 1, except that heat treatment was performed by setting the temperature of the roller to 150° C. and changing the contact time of the roller to 25 seconds in the production of the positive electrode, and heat treatment was performed by setting the temperature of the roller to 150° C. and changing the contact time of the roller to 30 seconds in the production of the negative electrode. H1, H2, H3, and H4 were 50 GPa, 100 GPa, 120 GPa, and 300 GPa, respectively.

### Example 7

A test cell was produced and evaluated in the same manner as in Example 1, except that in the production of the positive electrode, a portion corresponding to H1-1 of the positive electrode core exposed portion was heat-treated while being in contact with a roller at 150° C. for 25 seconds, and a portion corresponding to H1-2 of the positive electrode core exposed portion was heat-treated while being in contact with a roller at 150° C. for 10 seconds, and in the production of the negative electrode, heat treatment was performed by setting the temperature of the roller to 150° C. and changing the contact time of the roller to 15 seconds. H1-1, H1-2, H2, H3, and H4 were 50 GPa, 70 GPa, 100 GPa, 180 GPa, and 300 GPa, respectively. H1 was 60 GPa, the average of H1-1 and H1-2.

### Example 8

A test cell was produced and evaluated in the same manner as in Example 1, except that heat treatment was performed by setting the temperature of the roller to 150° C. and changing the contact time of the roller to 25 seconds in the production of the positive electrode, and heat treatment was performed by setting the temperature of the roller to 150° C. and changing the contact time of the roller to 8 seconds in the production of the negative electrode. H1, H2, H3, and H4 were 50 GPa, 100 GPa, 240 GPa, and 300 GPa, respectively.

### Example 9

A test cell was produced and evaluated in the same manner as in Example 1, except that in the production of the positive electrode, a portion corresponding to H1-1 of the positive electrode core exposed portion was heat-treated while being in contact with a roller at 150° C. for 25 seconds, and a portion corresponding to H1-2 of the positive electrode core exposed portion was heat-treated while being in contact with a roller at 150° C. for 10 seconds, and in the production of the negative electrode, heat treatment was not performed. H1-1, H1-2, H2, H3, and H4 were 50 GPa, 70 GPa, 100 GPa, 300 GPa, and 300 GPa, respectively. H1 was 60 GPa, the average of H1-1 and H1-2.

### Comparative Example 1

A test cell was produced and evaluated in the same manner as in Example 1, except that no heat treatment was performed in either the production of the positive electrode or the production of the negative electrode. H1, H2, H3, and H4 were 100 GPa, 100 GPa, 300 GPa, and 300 GPa, respectively.

### Comparative Example 2

A test cell was produced and evaluated in the same manner as in Example 1, except that in the production of the positive electrode, the entire surface of the aluminum foil was heat-treated while being in contact with a roller at 150° C. for 10 seconds, and in the production of the negative electrode, the entire surface of the copper foil was heat-treated while being in contact with a roller at 150° C. for 10 seconds. H1, H2, H3, and H4 were 70 GPa, 70 GPa, 210 GPa, and 210 GPa, respectively.

### Comparative Example 3

A test cell was produced and evaluated in the same manner as in Example 1, except that in the production of the positive electrode, the entire surface of the aluminum foil was heat-treated while being in contact with a roller at 150° C. for 30 seconds, and in the production of the negative electrode, the entire surface of the copper foil was heat-treated while being in contact with a roller at 150° C. for 30 seconds. H1, H2, H3, and H4 were 40 GPa, 400 GPa, 120 GPa, and 120 GPa, respectively.

Table 1 shows the evaluation results of the test cells according to Examples and Comparative Examples.

TABLE 1

| | | | | | Surface hardness | | | | | | |
|---|---|---|---|---|---|---|---|---|---|---|---|
| | Surface hardness of | | | | of negative | | | | | | |
| | positive electrode | | | | electrode core | | | | | Poor | Bonding |
| | core [GPa] | | | | [GPa] | | | | | elongation | failure |
| | H1-1 | H1-2 | H1 | H2 | H3 | H4 | H1/H2 | H1/H3 | H3/H4 | rate | rate |
| Example 1 | 70 | 70 | 70 | 100 | 210 | 300 | 0.7 | 0.33 | 0.7 | 0/100 | 4/100 |
| Example 2 | 40 | 40 | 40 | 100 | 120 | 300 | 0.4 | 0.33 | 0.4 | 0/100 | 0/100 |
| Example 3 | 50 | 50 | 50 | 100 | 180 | 300 | 0.5 | 0.28 | 0.6 | 0/100 | 0/100 |
| Example 4 | 40 | 40 | 40 | 100 | 240 | 300 | 0.4 | 0.17 | 0.8 | 7/100 | 7/100 |
| Example 5 | 60 | 60 | 60 | 100 | 90 | 300 | 0.6 | 0.67 | 0.3 | 1/100 | 0/100 |
| Example 6 | 50 | 50 | 50 | 100 | 120 | 300 | 0.5 | 0.42 | 0.4 | 0/100 | 0/100 |
| Example 7 | 50 | 70 | 60 | 100 | 180 | 300 | 0.6 | 0.33 | 0.6 | 0/100 | 0/100 |
| Example 8 | 50 | 50 | 50 | 100 | 240 | 300 | 0.5 | 0.21 | 0.8 | 0/100 | 7/100 |
| Example 9 | 50 | 70 | 60 | 100 | 300 | 300 | 0.6 | 0.2 | 1 | 0/100 | 14/100 |
| Comparative | 100 | 100 | 100 | 100 | 300 | 300 | 1 | 0.33 | 1 | 0/100 | 20/100 |
| Example 1 | | | | | | | | | | | |
| Comparative | 70 | 70 | 70 | 70 | 210 | 210 | 1 | 0.33 | 1 | 13/100 | 12/100 |
| Example 1 | | | | | | | | | | | |
| Comparative | 40 | 40 | 40 | 40 | 120 | 120 | 1 | 0.33 | 1 | 20/100 | 0/100 |
| Example 1 | | | | | | | | | | | |

As shown in Table 1, the test cells of Examples 1 to 9 successfully suppressed both welding failure and poor elongation. On the other hand, the test cells of Comparative Examples 1 to 3 failed to suppress both welding failure and poor elongation.

The present disclosure will be further described with the following embodiments.

### Constitution 1:

A cylindrical secondary battery comprising:
an electrode assembly in which a first electrode and a second electrode having different polarities from each other are wound via a separator;
a non-aqueous electrolyte; and
a bottomed cylindrical exterior housing can housing the electrode assembly and the non-aqueous electrolyte, wherein
the first electrode has a first core and a first mixture layer formed on a surface of the first core,
a first core exposed portion where the first core is exposed is disposed at one end of the electrode assembly in a winding axis direction, the first core exposed portion having a first bending point and being bonded to a first current collecting plate, and
when the first core exposed portion is divided into a first region extending from the first bending point toward the first current collecting plate and a second region extending from the first bending point toward the first mixture layer, surface hardness H1 of the first region and surface hardness H2 of the second region satisfy a relationship of H1<H2.

### Constitution 2:

The cylindrical secondary battery according to Constitution 1, wherein the H1 and the H2 satisfy a relationship of H1/H2<0.6.

### Constitution 3:

The cylindrical secondary battery according to Constitution 1 or 2, wherein when the first region is divided in half in a width direction of the electrode assembly such that a first bending point side is defined as a 1-1 region and a first current collecting plate side is defined as a 1-2 region, surface hardness H1-1 of the 1-1 region and surface hardness H1-2 of the 1-2 region satisfy a relationship of H1-1<H1-2.

### Constitution 4:

The cylindrical secondary battery according to any one of Constitutions 1 to 3, wherein
the first electrode is a positive electrode, and the second electrode is a negative electrode; and
the H1 satisfies 20 GPa<H1<100 GPa, and the H2 satisfies 50 GPa<H1<150 GPa.

### Constitution 5:

The cylindrical secondary battery according to any one of Constitutions 1 to 4, wherein
the first electrode is a positive electrode, and the second electrode is a negative electrode;
the second electrode has a second core and a second mixture layer formed on a surface of the second core,
a second core exposed portion where the second core is exposed is disposed on a surface of the second electrode, the second core exposed portion being in contact with only one end of the second electrode in a width direction and extending in a longitudinal direction of the second electrode with a substantially constant width;
the second core exposed portion is drawn out from an end surface of the electrode assembly substantially parallel to the winding axis direction of the electrode assembly, the second core exposed portion having a second bending point and being bonded to a second current collecting plate; and
when the second core exposed portion is divided into a third region extending from the second bending point toward the second current collecting plate and a fourth region extending from the second bending point toward the second mixture layer, surface hardness H3 of the third region and surface hardness H4 of the fourth region satisfy a relationship of H3<H4.

### Constitution 6:

The cylindrical secondary battery according to Constitution 5, wherein the H1 and the H3 satisfy a relationship of 0.25≤H1/H3≤1.1.

### Constitution 7:

The cylindrical secondary battery according to Constitution 5 or 6, wherein the H1 satisfies 20 GPa<H1<100 GPa, the H2 satisfies 50 GPa<H2<150 GPa, the H3 satisfies 100 GPa<H3<300 GPa, and the H4 satisfies 250 GPa<H4<500 GPa.

### Constitution 8:

The cylindrical secondary battery according to any one of Constitutions 1 to 3, wherein
the first electrode is a negative electrode, and the second electrode is a positive electrode; and
the H1 satisfies 100 GPa<H1<300 GPa, and the H2 satisfies 250 GPa<H1<500 GPa.

### REFERENCE SIGNS LIST

10 Cylindrical secondary battery, 11 Positive electrode, 12 Negative electrode, 13 Separator, 14 Electrode assembly, 15 Exterior housing can, 16 Sealing assembly, 17 Negative electrode current collecting plate, 18 Positive electrode current collecting plate, 19 Insulating plate, 20 Connection lead, 21 Grooved portion, 22 Filter, 23 Lower vent member, 24 Insulating member, 25 Upper vent member, 26 Cap, 26a Through hole, 27 Gasket, 30 Positive electrode core, 32 Positive electrode mixture layer, 34 Positive electrode core exposed portion, 40 Negative electrode core, 42 Negative electrode mixture layer, 44 Negative electrode core exposed portion

1. A cylindrical secondary battery comprising:
an electrode assembly in which a first electrode and a second electrode having different polarities from each other are wound via a separator;
a non-aqueous electrolyte; and
a bottomed cylindrical exterior housing can housing the electrode assembly and the non-aqueous electrolyte, wherein
the first electrode has a first core and a first mixture layer formed on a surface of the first core,
a first core exposed portion where the first core is exposed is disposed at one end of the electrode assembly in a winding axis direction, the first core exposed portion having a first bending point and being bonded to a first current collecting plate, and
when the first core exposed portion is divided into a first region extending from the first bending point toward the first current collecting plate and a second region extending from the first bending point toward the first mixture layer, surface hardness H1 of the first region and surface hardness H2 of the second region satisfy a relationship of H1<H2.

2. The cylindrical secondary battery according to claim 1, wherein the H1 and the H2 satisfy a relationship of H1/H2<0.6.

3. The cylindrical secondary battery according to claim 1, wherein when the first region is divided in half in a width direction of the electrode assembly such that a first bending point side is defined as a 1-1 region and a first current collecting plate side is defined as a 1-2 region, surface hardness H1-1 of the 1-1 region and surface hardness H1-2 of the 1-2 region satisfy a relationship of H1-1<H1-2.

4. The cylindrical secondary battery according to claim 1, wherein
the first electrode is a positive electrode, and the second electrode is a negative electrode; and
the H1 satisfies 20 GPa<H1<100 GPa, and the H2 satisfies 50 GPa<H2<150 GPa.

5. The cylindrical secondary battery according to claim 1, wherein
the first electrode is a positive electrode, and the second electrode is a negative electrode;
the second electrode has a second core and a second mixture layer formed on a surface of the second core,
a second core exposed portion where the second core is exposed is disposed at the other end of the electrode assembly in the winding axis direction, the second core exposed portion having a second bending point and being bonded to a second current collecting plate, and
when the second core exposed portion is divided into a third region extending from the second bending point toward the second current collecting plate and a fourth region extending from the second bending point toward the second mixture layer, surface hardness H3 of the third region and surface hardness H4 of the fourth region satisfy a relationship of H3<H4.

6. The cylindrical secondary battery according to claim 5, wherein the H1 and the H3 satisfy a relationship of 0.25≤H1/H3≤1.1.

7. The cylindrical secondary battery according to claim 5, wherein the H1 satisfies 20 GPa<H1<100 GPa, the H2 satisfies 50 GPa<H2<150 GPa, the H3 satisfies 100 GPa<H3<300 GPa, and the H4 satisfies 250 GPa<H4<500 GPa.

8. The cylindrical secondary battery according to claim 1, wherein
the first electrode is a negative electrode, and the second electrode is a positive electrode; and
the H1 satisfies 100 GPa<H1<300 GPa, and the H2 satisfies 250 GPa<H2<500 GPa.
